(19) United States
(12) Patent Application Publication
(10) Pub. No.: US 2010/0062207 A1
(43) Pub. Date: Mar. 11, 2010

(54) Blended bamboo and cotton chenille shag rug

(76) Inventor: Darryl S. Gold, Chesterfield, MO (US)

Correspondence Address: Paul M. Denk, 763 South New Ballas Road, St. Louis, MO, 63141, US

(21) Appl. No.: 12/584,745

(22) Filed: Sep. 11, 2009

Related U.S. Application Data
(60) Provisional application No. 61/191,674, filed on Sep. 11, 2008.

(51) Int. Cl. D05C 17/02; D05C 15/04; B32B 38/00; D02G 3/00

(52) U.S. Cl. 428/88; 156/148; 428/371

(57) ABSTRACT

A shag rug and method of making the same using smooth bamboo yarns formed in chenille pile. The smooth bamboo yarns have a low coefficient of friction and thus the rug and method utilize a blend of bamboo and combed cotton. The blended yarns are formed into chenille and shag of a dense woven character with a subtle sheen. To augment the bamboo yarns, blends of other fibers provide a cotton canvas base for the rug and a backing cloth beneath the base along with a polypropylene border. The blends of fibers vary according to the intended use and location of the shag rug. The shag rug of bamboo resists damage from water, mold, and mildew while limiting the retention of allergens in the bamboo fibers. The bamboo shag rug can be readily cleaned and dried.

### CROSS-REFERENCE TO RELATED APPLICATIONS

This non-provisional application for patent claims priority to the provisional application for patent having Ser. No. 61/191,674, which was filed on Sep. 11, 2008.

### BACKGROUND OF THE INVENTION

The processed bamboo fiber shag rug relates to floor coverings in general and more specifically to an allergen resistant and anti-microbial shag rug.

From earliest days, the bamboo plant has seen use in Asia for centuries and it has become an integral part of the Chinese culture. Bamboo has growing characteristics similar to pine, has pleasant esthetics, grows quickly, and serves as a renewable resource. Bamboo has seen usage in various industries and locations. In fiber form, or tian zhu, bamboo can be made into textiles of various kinds such as clothing, linens, and decorations for a home. Bamboo when prepared as a textile has a white color and useful properties for clothing and decorations. Particularly, bamboo fiber is receptive to various dyes, resistant to water and ultraviolet rays, and acts against viruses and other disease causing organisms. Presently, China and other Asian countries lead the world in bamboo production.

### DESCRIPTION OF THE PRIOR ART

Over the years, various forms of rugs and floor coverings have sought to protect floors from abrasion, to decorate homes, to muffle sounds, and to protect the inhabitants of a home. Additionally, rugs can be used in offices to reflect a certain status. Persian rugs with their intricate woven patterns have been desired for decades. Rugs have been made from wool, cotton, polyester, and various other materials to suit the tastes of a buyer and the uses imposed upon the rug. Some buyers seek a rug with extensive decoration for a living room or other formal place while use in a hallway calls for a rug of durable construction. Other buyers seek rugs with a smooth, or velvety, surface such as chenille pile. Such pile becomes smooth as an extra filling layer of yarns extends from cores during manufacturing into piles, exposing the soft ends of the yarn.

Chenille yarn entered production during the 1970's but had variations in yarn characteristics throughout manufacturing. Chenille itself has short lengths of spun yarn, also called pile, held in place by two strands of fine twisted yarn of greater strength than the spun yarn, also called the core. Various ingredients go into chenille though it has resulting sizes from coarse, at Nm 0.2, to fine, at Nm 12.0. Presently, machinery manufactures chenille by assembling the pile upon the core. Chenille manufacture begins with a polished metal stem, or a caliper, upon which the pile yarns wrap and then a blade passes through the caliper thus cutting the pile yarns in their classic short length. A rotating metal wheel then presses the core yarns upon the pile yarns. Then the combined yarn, pile and core, feeds upon an existing ring take up mechanism. During manufacture, two ends of core yarn mutually twist and simultaneously bind the pile yarn into the core yarns. The caliper size thus sets the diameter of the combined yarn while the size and number of pile yarns fed onto the core establishes the count for the combined yarn. Following manufacture of the combined yarn, the yarn then enters a dyeing phase where various colored dyes are taken up by the yarn for its use in weaving finished goods.

Chenille manufacture induces a wide variety of yields and twists in the combined yarn. Manufacturers now follow an international specification that guides the evaluation of chenille once made. Chenille yarn generally has from approximately 2% to 20% of count per yield and approximately 2% to 20% of twist. Count per yield follows the tension control of the yarn in known temperature and humidity. While, twist uses a standard twisting machine also in known environmental conditions.

However, the chenille manufacturing makes piles that lie in one direction thus when woven into a fabric, chenille pile has variations in light reflectivity depending on the viewer's location. Buyers of chenille products seek out this light reflectivity inherent in chenille. Achieving this feature calls for tight control of pile assembly, particularly direction, during manufacture. In the first half of manufacturing, the pile has a first direction though after the second half of manufacturing, the pile attains a second direction. Thus, a chenille yarn manufacturer takes the necessary steps to align the directions of the chenille yarn prior to shipment to a finished goods maker. A finished goods maker also must take steps that also keep the pile in the same direction during making of finished goods from chenille.

Moving beyond wool and cotton, various concerns have sought alternative materials and methods for rugs and floor coverings and related devices and methods. For example, the U.S. Pat. No. 4,156,298 to Spence describes a shag rug brushing and raking device. This device has a plurality of tines upon a wheeled cylinder that upon turning fluffs the strands of the nap of a shag rug.

The U.S. Pat. No. 4,504,537 to Mussallem describes a rug underlay. The underlay has an open weave lattice with fiber batting on each side punched into the lattice. An elastomeric material also provides a grid design for gripping a floor beneath a rug.

Neumayr describes a method of producing cellulose fiber from hydrocellulose in the U.S. Pat. No. 6,720,057. This method produces a fiber, including from bamboo, with a large surface area that results in fabric that retains liquids and other particles. Such fiber based fabric reduces the surface tension of water and aids in the cleaning and decontamination of various surfaces. The fibers blend into the environment with little damage upon disposal.

The U.S. Pat. No. 7,225,591 to Lin describes a flooring plank system. Adjacent planks join using strips in a pseudo tongue and groove connection. The strips have a bamboo bottom layer transverse to the grain of the plank and a bamboo top layer parallel to the grain of the plank. The strips allow for the planks to bend and to accommodate flooring irregularities.

Then the Chinese patent application to Hebei Jigao Cemical Fiber Co., No. 1308160 of August 2001, describes a process for preparing bamboo. The process takes raw bamboo as logged, washes it, then refines it with alkalis, bleaches, and acids. The process produces a viscous fiber pulp for various applications including paper and textiles.

Then the Chinese patent application to Hebei Jigao Optical Fiber Co., No. 1399011 of February 2003, shows another production process for bamboo. This process prepares raw bamboo with bleaching, acid treatments, and refining among other steps. This process yields bamboo viscous fiber of greater break strength than comparable textile fibers. The break strength is expressed in units of cN/dtex, which is the proportion of breaking force of the fiber, in Newtons, to the fiber's linear density, in kilograms per meter.

The prior art produces fiber from bamboo trees, or culms. The logging of bamboo trees, or culms, produces harvested logs that are then cut into smaller sections, and transported to a processing mill. The processing mill boils and steams the bamboo sections into thin sheets of bamboo pulp. Machinery then receives the pulp sheets and separates the bamboo fibers from the remainder of the pulp yielding thick and fluffy clumps of bamboo fiber. The clumps of fiber appear similar to natural cotton.

The clumps of bamboo fiber are then extended by machine into a rough yarn. The rough yarn then enters a centrifuge like machine that spins the yarn at high rates of revolutions and removes dust and other impurities from the rough yarn. The yarn then returns to loose fluffy bamboo fibers.

The fibers then enter a second centrifuge like machine that blows the fibers into processed yarns with smoothness comparable to silk. The bamboo yarns are then blended yarn of other fibers as later explained. The blended bamboo yarn is then rolled upon a loom machine for further compression and strengthening. The blended yarns then enter a further machine for winding onto elongated bobbins. The bobbins of blended yarn then enter another machine for rewinding into a truncated cone shape where the height of the cone is similar to the width of the base of the cones.

The blended yarn in conical form is then moved to other machines for further production steps. The present invention overcomes the difficulties of the prior art. The blended yarn provides the positive properties of bamboo with the binding properties of other fibers for use in rugs, particularly chenille. That is, the prior art has utilized bamboo production methods but not yet manufactured a shag rug. The present invention makes a shag rug of chenille like pile from smooth bamboo yarns blended with other textile fibers.

### SUMMARY OF THE INVENTION

Generally, the present invention is a chenille shag rug and method of making the same using primarily smooth bamboo yarn blended with cotton. The smooth bamboo yarns have a low coefficient of friction and thus the rug and the method utilize weaving and splicing techniques to connect smooth yarns. The yarns have a dense woven character with a subtle sheen. To augment the bamboo yarns, the present invention includes blends of other fibers, particularly combed cotton in a predetermined ratio. The cotton fibers provide a gripping surface for the bamboo fibers for sturdy chenille pile construction. The blends of fibers vary according to the intended use and location of the shag rugs of the present invention. The present invention has a preferred blend of approximately 80% by weight bamboo fiber and approximately 20% by weight combed cotton fiber.

There has thus been outlined, rather broadly, the more important features of the invention in order that the detailed description thereof that follows may be better understood and that the present contribution to the art may be better appreciated. The present invention also includes variations in the proportion of bamboo to cotton fibers and self-tightening weaving. Additional features of the invention will be described hereinafter and which will form the subject matter of the claims attached.

Numerous objects, features and advantages of the present invention will be readily apparent to those of ordinary skill in the art upon a reading of the following detailed description of the presently preferred, but nonetheless illustrative, embodiment of the present invention when taken in conjunction with the accompanying drawings. Before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, the phraseology and terminology employed herein are for the purpose of description and should not be regarded as limiting.

One object of the present invention is to provide a new and improved processed bamboo fiber shag rug.

Another object is to provide such a bamboo rug that remains whole yet, provides smooth chenille like surface texture.

Another object is to provide such a bamboo rug that resists abrasion from footwear and furniture in a residential or office setting.

Another object is to provide such a bamboo rug that comes from a renewable and sustainable resource.

Another object is to provide such a bamboo rug that has a luxuriant feel to the touch, also called “hand”.

Another object is to provide such a bamboo rug that resists stains, microbial attack, bacterial growth, accumulation of odors, water and is hypoallergenic.

Another object is to provide such a bamboo rug that is well suited to both indoor and outdoor use.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In referring to the drawings,

FIG. 1 illustrates a perspective view of the preferred embodiment of the present invention;

FIG. 2 shows a sectional view along the perimeter of the invention;

FIG. 3 shows a detailed view of a straight chenille pile of the invention; and,

FIG. 4 shows a detailed view of a curved chenille pile of the invention.

The same reference numerals refer to the same parts throughout the various figures.

### DESCRIPTION OF THE PREFERRED EMBODIMENT

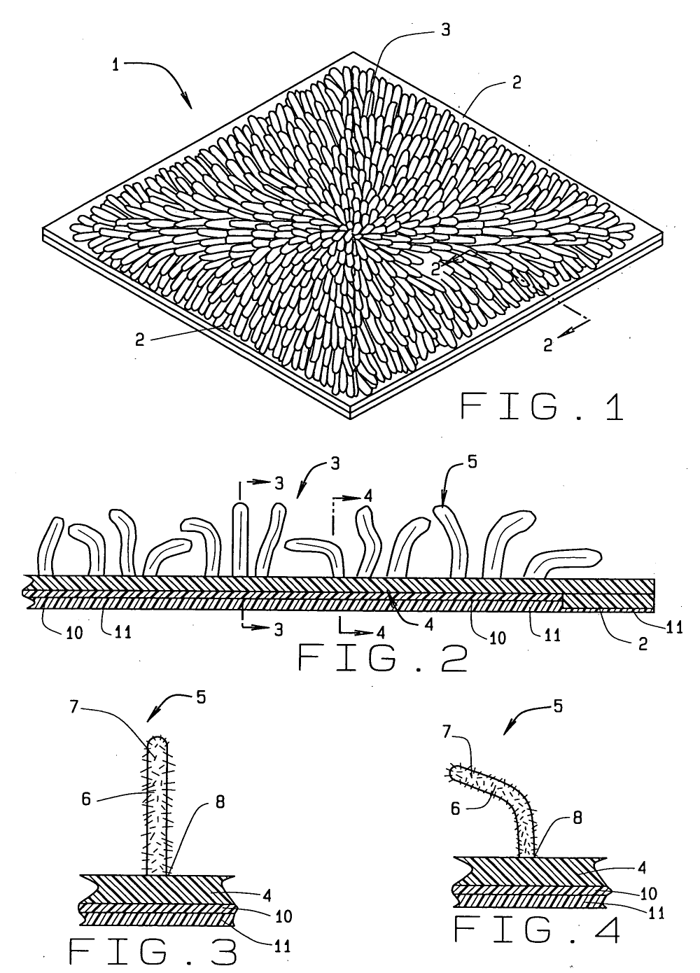

The present invention overcomes the prior art limitations and provides a shag rug of processed bamboo fiber as shown in FIG. 1. The rug 1 has a generally planar shape, here shown as rectangular, though other shapes are permitted. The rug has a finished border 2 upon its perimeter to suit various tastes and decors while binding the edges of the rug. Within the border, the rug has a body 3 displaying various colors and patterns. The body has a plurality of shag chenille piles. The piles attain a random arrangement where individual piles curve and bend in no particular pattern. The bends and curves expose the soft, spun yarn filaments extending from the core of a pile.

The present invention includes yarns woven into piles that comprise approximately 35% to approximately 85% bamboo and approximately 65% to approximately 15% of other textiles respectively. In the preferred embodiment, the yarn has 80% bamboo fiber blended with 20% cotton fiber. A further alternate embodiment includes a 50% bamboo and 50% cotton fiber blend. The fiber components and proportion of bamboo to cotton fibers in the preferred embodiment allow the bamboo fibers to grip the cotton fibers when the blended fibers have the chenille form. The bamboo piles hold together in a chenille rug with the assistance of the cotton fibers. The bamboo fiber of the present invention comes from independently certified mills near the forests of bamboo.

In a further alternate embodiment, the piles have a blend of 80% bamboo fiber and 20% combed cotton. The combed cotton has greater softness than common cotton which leads to more luster and palpable softness. At time of blending, the manufacturing mill places its own certification upon the bamboo and cotton blend. The mill certification provides the bamboo percentage that rug weaving factory insist upon. Along with certification programs, the present invention utilizes spares imported from South Korean sources to maintain the quality of the chenille and its greater softness. The use of combed cotton and certification at blending mills early in manufacturing leads to the best outcome in final production of rugs that consumers purchase.

Once the blended bamboo and cotton fiber yarn arrives at the factory, the factory converts the yarn into chenille upon a high strength cotton core. The cotton core provides sufficient strength for the tufting process of making a shag rug. The cotton core differs from the prior art where manufacturers utilize a polyester and cotton blend. The polyester fiber lowers the price of the core however, the polyester causes environmental concerns as a petroleum derivative. The present invention excludes polyester fibers from its construction. The blended yarn becomes chenille pile upon precise machinery at the factory. The machinery provides a good finish and evenness of each pile that leads to consistent chenille piles. The factory and its staff insist upon consistent pile quality and finish which ultimately leads to a high quality rug. The factory ensures the quality of the pile by inspecting the twenty heads upon the machinery before the start of each run of chenille pile manufacture. The factory has a highly specially trained artisan, or millwright, who performs the inspection of the machine heads. Behind the artisan, the factory owners also perform regular inspections of the machinery, yarn, and resulting chenille. Along with the artisans and factory owners, other workers at various steps in production of chenille also inspect their work in progress at regular intervals.

Viewing the rug in more detail, FIG. 2 shows a section of the rug where the border 2 adjoins the body 3. The border extends from a base 4 or backing, preferably heavy duty canvas, generally 100% cotton, that forms the bottom surface of the entire rug, generally opposite the body. The canvas is procured in whole lots for consistent performance and cost savings as opposed to canvas cut to rug sizes which introduces the risk of variation in the canvas fabric. The border has a firm perimeter edge from a fold of the base. The base holds the body and border together and receives the piles 5 tufted into the base 4. In this embodiment, the cones of blended yarn provide at least two strands of yarn continuously to a tufting machine. The tufting machines insert the strands of blended yarn through the backing into piles 5. The tufting places the manufactured chenille upon the cotton canvas cloth backing in a desired size. The tufting process also undergoes a rigorous inspection program.

A pile using the bamboo fibers of the invention appears in more detail within FIG. 3. The base 4 forms the support of all of the piles and the border that form a rug. One pile is shown here for illustration though a complete rug has numerous piles locating close together at the base but then bending and curving at random as previously shown in FIG. 1. Generally, each pile 5 has a core 6 tufted into the backing upon one end and with an opposite free end. Spun yarn filaments 7 then extend outwardly from the core to a predetermined length, confirmed by the various inspection steps during manufacturing. This figure shows a chenille pile in a generally upright orientation and perpendicular to the backing 4. The filaments provide the soft feel of the piles, desired by customers. The chenille piles of the present invention have a plush and thick form ideally suited for making into a shag rug by primarily tufting or alternatively weaving or adhesives.

For a smoother feel of the rug, FIG. 4 describes a singe pile 5 that has curved. Though a single pile is shown, the piles in the body 3 are generally numerous. This pile exposes more filaments 7 to the touch of a customer as more of its length approaches the backing. The core curves or bends depending upon its tension from manufacturing and later from temperature, humidity, and usage at the rug's final location. The pile may bend and curve in three directions though its base 8 remains fixed to the backing.

Though chenille pile construction of cores and filaments has been described, the initial yarns and resulting chenille share similar components. By itself, bamboo fiber has little surface roughness and provides a smooth feel to the touch. The bamboo fiber has a lack of surface pores leading to a smooth texture. However, bamboo fiber alone does not hold together when in the form of chenille pile, particularly as a chenille rug. The bamboo cores do not bind the bamboo filaments. To capitalize on the positive properties of bamboo fiber and allow the bamboo fiber to become part of chenille, the bamboo fiber requires a blend with other fibers. The bamboo fibers of the present invention resist microbes, odors, and water, and are hypoallergenic. The bamboo and combed cotton chenille piles in the present invention can be dyed to suit the preferences of the consumer.

Alternatively, the rug 1 of the invention has piles 5 woven of bamboo and other piles woven of other fibers. The piles of other fibers are located adjacent to the piles of bamboo fibers across the base 4 through the body 3 of the rug. The bamboo piles and other fiber piles are dispersed across the rug. The piles generally have a ratio of bamboo pile to other fiber piles of approximately 35% to approximately 85% bamboo piles and approximately 15% to approximately 65% other fibers. The other fibers include jute and wool along with other animal and plant fiber sources. In the alternate embodiment, each pile exhibits the properties of its material independently of adjacent piles. When viewed as a whole for a rug, the piles of other fibers adjacent to the piles of bamboo fiber provide the appearance and attributes of a blended fiber pile.

After assembly and sewing, the rug 1 with the various piles 5 undergoes a dying process through a dying machine. Within the machine, various predetermined dyes enter the piles of the rug to provide rugs of selected colors for customers. The dyes are of the highest quality from international sources and are also of environmentally friendly colors. The dyes are Azo Free. The rugs soak for many hours in dying vats to achieve a suitable color of appropriate intensity. Following dying, the colored rugs are dried and undergo another inspection for quality standards and sizing. The sizing is slightly over final size to allow for shrinkage in the remaining steps of manufacturing and distribution. The inspection weeds out rugs too small for shipment. Opposite the piles, the dyed and dry rug has a layer of natural latex applied as at 10 to assist in binding the chenille piles to the canvas base 4. The latex serves to separate the tufted bamboo/combed cotton chenille layer from the base of heavy cotton canvas backing. The latex layer strengthens the natural fiber rug of this invention. Once the latex has dried, the backing cloth 11 is adhered to the latex upon the entire bottom of the rug for a clean base surface applied to the floors of a home or office. And finished rugs undergo a hand inspection that checks for perfect consistency of tufting, quality of chenille, color, thickness of chenille, pile height of chenille, sewing quality, and the quality of final assembly. Rugs that pass all of the inspections are then shipped to distributors for delivery to users. The inspections and checking of rugs many times at many levels ensures a consistent end product that leads to satisfied customers.

From the aforementioned description, a processed fiber bamboo shag rug has been described. The bamboo fiber shag rug is uniquely capable of resisting foods and liquids inadvertently spilled upon it, resisting microbes, avoiding allergic reactions in people, and supporting a sustainable raw material. The bamboo fiber shag rug and its various components may be manufactured from many materials, including but not limited to, bamboo, cotton, polypropylene borders, canvas backing, other textile fibers, and their blends.

As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

I claim:

1. A covering for a floor that resists microbes, water, and allergens, comprising:
a base having a generally planar shape, two opposite surfaces, one surface having a latex coating,
a border upon the perimeter of said base;
a body within said border, said body having a plurality of closely packed piles of smooth material, said piles including approximately 65% to approximately 85% bamboo fiber and approximately 35% to 15% combed cotton fiber, said body locating opposite the surface coated in latex; and
a backing upon said base locating upon the surface coated in latex.

2. The floor covering of claim 1 further comprising:
each of said piles having a core with embedded filaments forming chenille.

3. The floor covering of claim 2 further comprising:
each of said cores having two strands of yarn.

4. The floor covering of claim 2 wherein said piles include 80% bamboo fiber and 20% combed cotton fiber.

6. The floor covering of claim 2 wherein said base is cotton canvas and said backing is cloth.

7. The floor covering of claim 2 wherein said border is polypropylene.

8. A yarn for a floor covering that resists microbes, water, mold, and allergens, said yarn coming from a renewable resource, said yarn readily drying, said yarn being cleaned readily, said yarn comprising:
approximately 35% to approximately 85% bamboo fiber and approximately 15% to approximately 65% combed cotton fiber, and preferably 80% bamboo fiber and 20% combed cotton fiber.

9. A method of preparing smooth bamboo fibers into chenille piles for a shag rug comprising:
blending bamboo fiber and at least on other textile fiber;
spinning a yarn of said blended bamboo fiber;
placing yarn filaments upon a core;
forming said core into a chenille pile using a caliper;
tufting said chenille pile through a backing repeatedly to form a rug;
dying said rug to a predetermined color;
applying a layer of latex to said backing; and
adhering a backing cloth to said latex layer.

10. The bamboo piles as a shag rug method of claim 9 wherein said at least one other textile is one of cotton, combed cotton, wool, or jute fiber.

11. The bamboo piles as a shag rug method of claim 10 further comprising:
said blending of bamboo fiber including 80% by weight bamboo and 20% by weight combed cotton.
